(19) United States
(12) Patent Application Publication
(10) Pub. No.: US 2008/0006779 A1
(43) Pub. Date: Jan. 10, 2008

(54) Radiation image conversion panel production process and radiation image conversion panel obtained thereby

(75) Inventors: Keiichiro Sato, Kanagawa (JP); Yuji Isoda, Kanagawa (JP); Munetaka Kato, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/822,794

(22) Filed: Jul. 10, 2007

(30) Foreign Application Priority Data
Jul. 10, 2006 (JP) 2006-189131

(51) Int. Cl. G21K 4/00; G01T 1/00

(52) U.S. Cl. 250/483.1; 427/65

(57) ABSTRACT

The process for producing a radiation image conversion panel forms a phosphor layer on a substrate by vapor-phase deposition in a vacuum chamber and subjects the formed phosphor layer to a thermal treatment to obtain the radiation image conversion panel. The phosphor layer is protected by a selectively permeable cover after completion of the vapor-phase deposition until completion of the thermal treatment. Or the foreign matter on a surface of the phosphor layer is removed prior to the thermal treatment performed on the phosphor layer.

The entire contents of documents cited in this specification are incorporated herein by reference.

### BACKGROUND OF THE INVENTION

The present invention relates to a radiation image conversion panel production process that may be used when a radiation image is recorded (taken) by, for example, computed radiography (CR), and a radiation image conversion panel obtained by this method. More particularly, the invention relates to a radiation image conversion panel production process that prevents adhesion of dirt, dust and the like to the surface of a phosphor layer made up of columnar crystals (a so-called stimulable phosphor layer) and staining (discoloration) during the subsequently performed thermal treatment, thus enabling a high-quality image with fewer point defects to be obtained, and a radiation image conversion panel obtained by this method.

Upon exposure to a radiation (e.g. X-rays, α-rays, β-rays, γ-rays, electron beams, and ultraviolet rays), certain types of phosphors known in the art accumulate part of the energy of the applied radiation and, in response to subsequent application of exciting light such as visible light, they emit photostimulated luminescence in an amount that is associated with the accumulated energy. Called “storage phosphors” or “stimulable phosphors”, those types of phosphors find use in medical and various other fields.

A known example of such use is a radiation image information recording and reproducing system that employs a radiation image conversion panel having a film (or layer) of the stimulable phosphor. The system has already been commercialized by, for example, FUJIFILM Corporation under the trade name of FCR (Fuji Computed Radiography).

In that system, a subject such as a human body is irradiated with X-rays or the like to record radiation image information about the subject on the radiation image conversion panel (more specifically, the stimulable phosphor layer). After the radiation image information is thus recorded, the radiation image conversion panel is scanned two-dimensionally with exciting light such as laser light to emit photostimulated luminescence which, in turn, is read photoelectrically to yield an image signal. Then, an image reproduced on the basis of the image signal is output as the radiation image of the subject, typically to a display device such as a CRT (cathode ray tube) display or an LCD (liquid crystal display), or on a recording material such as a photosensitive material.

The radiation image conversion panel is typically prepared by the following method: Powder of a stimulable phosphor is dispersed in a solvent containing a binder and other necessary ingredients to make a coating solution, which is applied to a panel-shaped support made of glass or a resin, with the applied coating being subsequently dried.

Also known are phosphor panels which are prepared by forming a stimulable phosphor layer (hereinafter also referred to simply as a “phosphor layer”) on a support through vacuum film deposition techniques (vapor-phase film deposition techniques) such as vacuum evaporation and sputtering. The phosphor layer formed by such vacuum film deposition techniques has superior characteristics in that it is formed in vacuo and hence has low impurity levels and that being substantially free of any ingredients other than the stimulable phosphor as exemplified by a binder, the phosphor layer not only has small scatter in performance but also features very highly efficient luminescence. In addition, since the phosphor layer formed has a phosphor of a columnar structure, satisfactory image quality including high sharpness is achieved.

The radiation image conversion panel may cause defects on resulting images in the case where foreign matter such as dirt or dust adhered to the panel during the reading process, and in the case where foreign matter such as dirt or dust was incorporated in the panel during the manufacturing process. In order to suppress occurrence of such image defects, various techniques have been disclosed (see JP 5-72656 A, JP 11-344781 A, JP 2005-43050 A and JP 2005-227064 A).

JP 5-72656 A discloses a radiation image reading apparatus provided with a mechanism of cleaning a stimulable phosphor sheet. The cleaning mechanism disclosed in JP 5-72656 A has a rotating cleaning roller pair and a static eliminator brush pair.

The radiation image reading apparatus of JP 5-72656 A uses the cleaning mechanism to remove foreign matter adhering to the surface of the phosphor sheet and electric charges on its surface, thus eliminating adverse effects of the electric charges or adhering dust on a resulting radiation image.

JP 11-344781 A discloses a radiation image reading apparatus in which a transport system for transporting a stimulable phosphor panel on which a radiation image has been recorded includes a plurality of elastic belts arranged so as to lie on both sides of the stimulable phosphor panel.

In the radiation image reading apparatus of JP 11-344781 A, the elastic belts are driven to transport the stimulable phosphor panel sandwiched between the elastic belts, which prevents scratching on the stimulable phosphor panel during its transport, deterioration with time due to generated distortion, and also adhesion of foreign matter such as dust and dirt to the stimulable phosphor panel during its transport. JP 11-344781 A also prevents adhesion of dirt to the phosphor layer and image deterioration that may occur during image reading.

In addition, JP 2005-43050 A discloses a radiation image conversion panel production process which has a step of bonding a protective layer and a phosphor layer together after dirt on the surface of at least one of the protective layer and the phosphor layer has been removed by a removal method using adhesive force.

The radiation image conversion panel production process in JP 2005-43050 A thus includes the step using the dirt removal method, and enables an excellent image with less noise to be obtained by preventing deterioration of the accuracy in image reading on a repeatedly used radiation image conversion panel due to dirt and dust that were incorporated into the reading section through a transport system or other component, or adhered to the stimulable phosphor sheet.

JP 2005-227064 A discloses a radiation image conversion panel in which at least one protective layer is formed on the surface of a phosphor layer of the radiation image conversion panel in order to achieve high resistance to water and solvents and suppress occurrence of image defects due to adhesion of foreign matter such as dirt while maintaining high image quality in the radiation image conversion panel. The protective layer is added in the step of incorporating a phosphor sheet into the radiation image conversion panel after the phosphor sheet constituting the radiation image conversion panel has been formed.

### SUMMARY OF THE INVENTION

The radiation image reading apparatus in JP 5-72656 A and JP 11-344781 A which are capable of removing dirt having adhered during image reading has a problem that dirt having been incorporated in the radiation image conversion panel cannot be removed.

JP 2005-43050 A is directed not to suppress incorporation of dirt and dust during the formation of the phosphor layer but to prevent incorporation of dirt between the protective layer and the phosphor layer. As a result, in the case where foreign matter such as dirt and dust has been incorporated during the formation of the phosphor layer, the thus produced radiation image conversion panel may cause the image defects as described below.

Hillocks (abnormally projected portions) have been conventionally known to cause image defects. As is seen from a radiation image conversion panel 200 shown in FIG. 9, an image defect may occur due to dirt or other factor, although normally columnar crystals 206 grow to form a stimulable phosphor layer (phosphor layer) 204 whose surface 204a has a substantially uniform height.

To be more specific, if dirt 208 adheres to a substrate 202 when the phosphor layer 204 is to be formed on the substrate 202, a crystal 206a abnormally grows from the dirt 208 serving as the starting point, consequently causing a hillock Hi which projects from the surface 204a of the phosphor layer 204. The crystal 206a having abnormally grown causes a resulting image to have a point defect that an inherently black portion is rendered white. It is not always possible to produce a radiation image conversion panel with which high-quality images having fewer defects are obtained unless contamination by dirt and dust as described above is suppressed.

Aside from this, the inventors of the present invention have found that, if foreign matter such as dirt and dust adheres to the surface of a phosphor layer when the phosphor layer formed is to be subjected to a thermal treatment to enhance its sensitivity, the dirt and dust may melt during the thermal treatment and penetrate the interior of the phosphor layer, and in such a case, staining (discoloration) may occur on the phosphor layer surface to pose serious problems such as occurrence of point defects on radiation images as in the case of the above-mentioned hillocks.

More specifically, in the case shown in FIG. 10A in which two pieces of dirt (e.g., organic matter such as skin of a human body) 216a, 216b adhere to the surface of a phosphor layer 214 on a substrate 212 of a radiation image conversion panel 210, the pieces of dirt 216a, 216b are melted as shown in FIG. 10B by heat generated in the thermal treatment (annealing) of the radiation image conversion panel 210 within a thermal treatment unit, which causes staining (discoloration) as shown by reference numerals 218a and 218b resulting in point defects on a radiation image.

Staining (discoloration) on the surface of the phosphor layer occurs during the thermal treatment due to melting of dirt or dust adhering to the phosphor layer surface, whereas the above-mentioned hillocks occur due to abnormal crystal growth in the phosphor layer formed by vapor-phase deposition. Therefore, measures to be taken to prevent the staining (discoloration) and those to be taken to prevent the hillocks are different from each other.

The present invention has been made to solve the abovementioned conventional problems and an object of the present invention is to provide a radiation image conversion panel production process which keeps dirt and dust from adhering to the surface of a phosphor layer to prevent staining (discoloration) of the phosphor layer surface during the thermal treatment, thus enabling a high-quality image with fewer point defects to be obtained.

Another object of the present invention is to provide a radiation image conversion panel that causes no point defect on a radiation image and which is produced by the radiation image conversion panel production process as described above.

In order to attain the object described above, a first aspect of the invention provides a process for producing a radiation image conversion panel comprising the steps of forming a phosphor layer on a substrate by vapor-phase deposition in a vacuum chamber, and subjecting the formed phosphor layer to a thermal treatment to obtain the radiation image conversion panel, wherein the phosphor layer is protected by a selectively permeable cover after completion of the vapor-phase deposition until completion of the thermal treatment.

The cover is used to prevent adhesion of foreign matter such as dirt and dust while the whole surface of a phosphor sheet is kept under uniform temperature and humidity conditions. For example, an aluminum plate that has a large number of fine pores formed therein and has supporting legs for holding the plate so as not to contact the surface of the phosphor sheet may be advantageously used.

Preferably, the selectively permeable cover has fine pores with a diameter of 1 μm to 1.5 mm.

It is preferable that the process further comprises the step of keeping the phosphor layer under predetermined temperature and humidity conditions for a predetermined period of time prior to a thermal treatment to be performed on the phosphor layer. That is to say, a second aspect of the invention provides a process for producing a radiation image conversion panel comprising the steps of forming a phosphor layer on a substrate by vapor-phase deposition in a vacuum chamber, keeping the phosphor layer under predetermined temperature and humidity conditions for a predetermined period of time prior to a thermal treatment to be performed on the phosphor layer (hereinafter, referred to as the humidification step), and subjecting the phosphor layer to the thermal treatment to obtain the radiation image conversion panel, wherein the phosphor layer is protected by a selectively permeable cover after completion of the vapor-phase deposition until completion of the thermal treatment.

Preferred examples of the temperature and humidity conditions in the humidification step include a humidification for 0.5 hours to 168 hours in an environment of a temperature of 10° C. to 60° C. and a relative humidity of 20% to 45% RH (that is, the humidification step of keeping the phosphor layer in the above environment for 0.5 hours to 168 hours).

Another example of the preferred temperature and humidity conditions is a humidification for a predetermined period of time in an environment of a temperature being 10° C. to 60° C. and a relative temperature H satisfying the expression: 45% RH<H≦80% RH, wherein X is 0.2 to 210 in the following formula: X=[exp (6.4×10⁻²×(T+273))×H×10⁻¹⁰×t] where the predetermined period of time represents t [hours].

Still another example of the preferred temperature and humidity conditions is a humidification for 10 to 30 minutes in an environment of a temperature being 10° C. to 60° C. and a relative humidity H satisfying the expression: 80% RH<H<90% RH.

The temperature and humidity conditions are determined as described above based on the findings through experiments by the present inventors that there is an optimum period of time for the humidification step depending on a temperature and humidity at a place where the humidification step is performed. In practice, a period of time for the humidification step may be determined in accordance with a temperature and humidity at a place where the humidification step is performed after the temperature and humidity are settled according to an environment of the place such as a manufacturing site.

The humidification step has effects of advantageously preventing the deterioration of phosphor layer properties during the period after a completion of deposition until a start of thermal treatment as described in Japanese Patent Application No. 2003-205392 (JP 2005-55185 A) under the title of “MANUFACTURING METHOD FOR STIMULABLE PHOSPHOR PANEL” proposed by the present applicant prior to the present application, and in addition, of improving photostimulated luminescence characteristics such as PSL sensitivity.

Preferably, the phosphor layer is protected by the selectively permeable cover at least in the step of keeping the phosphor layer under the predetermined temperature and humidity conditions for the predetermined period of time (humidification step).

Preferably, the selectively permeable cover has fine pores with a diameter of 1 μm to 1.5 mm.

In order to attain the object described above, a third aspect of the invention provides a process for producing a radiation image conversion panel comprising the steps of forming a phosphor layer on a substrate by vapor-phase deposition in a vacuum chamber, removing foreign matter on a surface of the phosphor layer, and subjecting the phosphor layer to a thermal treatment to obtain the radiation image conversion panel, wherein the foreign matter on the surface of the phosphor layer is removed prior to the thermal treatment performed on the phosphor layer.

Preferably, the foreign matter on the surface of the phosphor layer is removed by blowing air onto the surface of the phosphor layer at a rate of at least 2 m/s.

Preferably, the foreign matter on the surface of the phosphor layer is removed by bringing an adhesive material into contact with the surface of the phosphor layer.

Preferably, a butyl rubber roller is used for the adhesive material.

It is preferable that the process further comprises the step of keeping the phosphor layer under predetermined temperature and humidity conditions for a predetermined period of time prior to a thermal treatment to be performed on the phosphor layer. That is to say, a fourth aspect of the invention provides a process for producing a radiation image conversion panel comprising the steps of forming a phosphor layer on a substrate by vapor-phase deposition in a vacuum chamber, keeping the phosphor layer under predetermined temperature and humidity conditions for a predetermined period of time prior to a thermal treatment to be performed on the phosphor layer, and subjecting the phosphor layer to the thermal treatment to obtain the radiation image conversion panel, wherein foreign matter on a surface of the phosphor layer is removed prior to the thermal treatment.

Preferably, the foreign matter on the surface of the phosphor layer is removed by blowing air onto the surface of the phosphor layer at a rate of at least 2 m/s.

Preferably, the foreign matter on the surface of the phosphor layer is removed by bringing an adhesive material into contact with the surface of the phosphor layer.

Preferably, a butyl rubber roller is used for the adhesive material.

In order to attain another object described above, a fifth aspect of the invention provides a radiation image conversion panel that is produced by a process according to any one of the above first to fourth aspects of the invention.

The radiation image conversion panel production process of the present invention including the steps of forming a phosphor layer on a substrate by vapor-phase deposition in a vacuum chamber and subjecting the thus formed phosphor layer to a thermal treatment has a feature that the phosphor layer formed by vapor-phase deposition is protected by a selectively permeable cover until the end of the thermal treatment and has an effect of preventing adhesion of foreign matter (such as dirt and dust) onto the surface of the formed phosphor layer.

The radiation image conversion panel production process of the present invention has a feature that foreign matter on the phosphor layer surface is removed before the phosphor layer formed is thermally treated and has an effect of preventing staining (discoloration) that may occur on the phosphor layer surface during the thermal treatment.

The radiation image conversion panel production process of the present invention preferably includes the step of keeping the phosphor layer before being subjected to the thermal treatment under predetermined temperature and humidity conditions for a predetermined period of time (humidification step) in the manufacture of a radiation image conversion panel. In such a case, it is effective to protect the phosphor layer by the selectively permeable cover at least during the keeping step.

Various methods such as a non-contact method (e.g., a removal method by means of air blowing) and a contact method (e.g., a removal method using an adhesive material) may be employed for removing foreign matter on the phosphor layer surface.

It is to be understood that the radiation image conversion panel which has the phosphor layer and which is produced by the radiation image conversion panel production process of the present invention is a radiation image conversion panel causing no point defects on a resulting radiation image.

### BRIEF DESCRIPTION OF THE DRAWINGS

FIG. 1A is a schematic sectional view showing an embodiment of an apparatus for producing radiation image conversion panels as used in a radiation image conversion panel production process of the present invention;

FIG. 1B is a schematic side sectional view of the apparatus shown in FIG. 1A;

FIGS. 2A, 2B and 2C are a plan view, a front view and a side view schematically showing a substrate holding and transporting mechanism of the apparatus for producing radiation image conversion panels shown in FIG. 1A, respectively;

FIG. 3 is a schematic plan view showing a thermal evaporating section of the apparatus for producing radiation image conversion panels shown in FIG. 1A;

FIG. 4 is a flow diagram showing a step of attaching a dust-proof cover in an embodiment of the radiation image conversion panel production process;

FIG. 5 is a schematic side view showing how the dust-proof cover used in an embodiment of the radiation image conversion panel production process is attached to a phosphor sheet;

FIG. 6 is a schematic sectional view showing a radiation image conversion panel produced by an embodiment of the radiation image conversion panel production process;

FIG. 7 is a schematic side view showing how dirt is removed in an embodiment of the radiation image conversion panel production process;

FIG. 8 is a schematic side view showing how dirt is removed in another embodiment of the radiation image conversion panel production process;

FIG. 9 is a schematic view illustrating a case in which dirt that may cause a point defect occurs in a radiation image conversion panel; and

FIGS. 10A and 10B are schematic views illustrating another case in which dirt that may cause point defects occurs in a radiation image conversion panel.

### DETAILED DESCRIPTION OF THE PREFERRED EMBODIMENTS

On the pages that follow, the radiation image conversion panel production process and the radiation image conversion panel obtained thereby according to the present invention are described in detail with reference to the preferred embodiments depicted in the accompanying drawings.

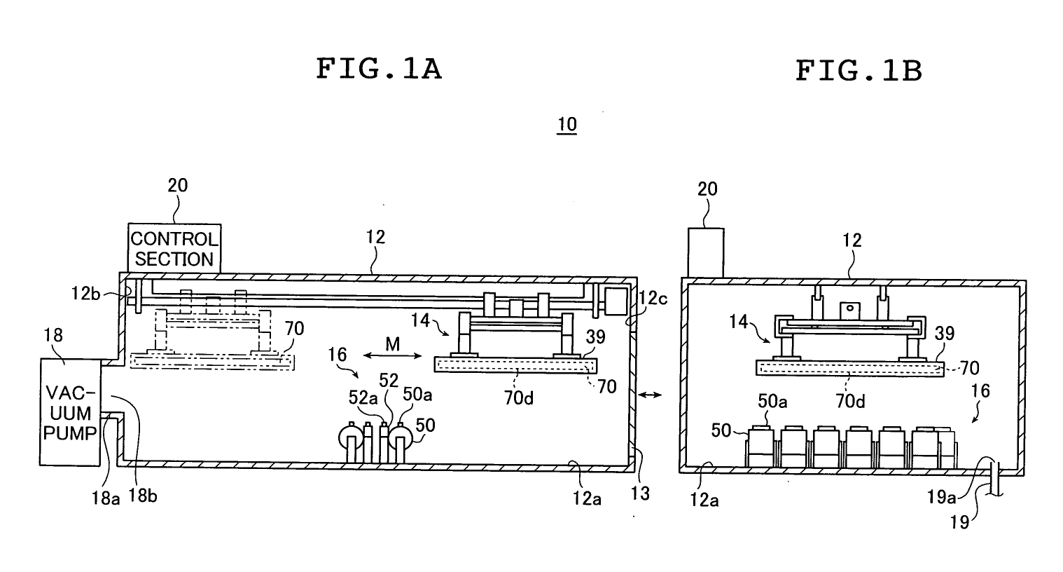

FIG. 1A is a schematic sectional view showing an exemplary apparatus for producing radiation image conversion panels as used in a radiation image conversion panel production process of the present invention. FIG. 1B is a schematic side sectional view of the apparatus for producing radiation image conversion panels shown in FIG. 1A.

In an apparatus for producing radiation image conversion panels (hereinafter also referred to simply as a “production apparatus”) 10 shown in FIGS. 1A and 1B, two-source vacuum evaporation in which a material for a stimulable phosphor (matrix) and a material for an activator are separately evaporated is applied to form a phosphor layer comprising a stimulable phosphor on a surface 70d of a substrate 70 to thereby produce a (stimulable) radiation image conversion panel.

The production apparatus 10 basically includes a vacuum chamber 12, a substrate holding and transporting mechanism 14, a thermal evaporating section (resistance heating means) 16, a vacuum pump (vacuum pumping means) 18, a gas introducing nozzle 19 and a control section 20. Needless to say, the production apparatus 10 of the embodiment under consideration may optionally have various other components of known apparatuses for vacuum evaporation. For example, the production apparatus 10 may include a vacuum gauge (not shown) for measuring the degree of vacuum within the vacuum chamber 12, which is connected to the control section 20.

In this embodiment, the substrate 70 is set in the vacuum chamber 12 for the linear transport in such a manner that a substrate holder 39 containing the substrate 70 is held by the substrate holding and transporting mechanism 14.

The substrate holder 39 is designed so that the substrate 70 is inserted from the lateral side of the substrate holder 39 in its interior, and is fitted and held in the substrate holder 39.

The apparatus of the present invention is not limited to the two-source vacuum evaporation apparatus as shown in FIGS. 1A and 1B, but may be a one-source vacuum evaporation apparatus in which all necessary film-forming materials are mixed and accommodated in evaporation sources. If desired, apparatuses capable of multi-source vacuum evaporation in which three or more components are vapor-deposited may be employed. It is preferable to use an apparatus of a type that performs multi-source vacuum evaporation in which two or more film-forming materials are accommodated in separate evaporation sources.

In a preferred version of the illustrated embodiment, cesium bromide (CsBr) serving as the phosphor component and europium bromide [EuBrₓ (x is typically 2 or 3, with 2 being particularly preferred)] serving as the activator component are used as film-forming materials and two-source vacuum evaporation is performed through resistance heating to deposit a phosphor layer of the stimulable phosphor CsBr:Eu on the substrate 70, thereby forming a radiation image conversion panel.

The production apparatus 10 having the gas introducing nozzle 19 through which an inert gas is introduced into the vacuum chamber during film deposition is preferably operated as follows: The vacuum chamber 12 is first evacuated to a high degree of vacuum and with continued evacuation, an inert gas is introduced into the vacuum chamber 12 through the gas introducing nozzle 19 until the pressure in the vacuum chamber 12 is reduced to about 0.1 Pa to 10 Pa (this degree of vacuum is hereinafter referred to as the “medium degree of vacuum”) and under this medium degree of vacuum, the film-forming materials (cesium bromide and europium bromide) are heated to evaporate through resistance heating in the thermal evaporating section 16 as the substrate 70 is transported linearly by means of the substrate holding and transporting mechanism 14 (this movement is hereinafter referred to as “linear transport”), whereby a phosphor layer is formed on the substrate 70 by vacuum evaporation.

In the present invention, various materials may be used for the stimulable phosphor constituting the phosphor layer and preferred examples are given below.

Stimulable phosphors disclosed in U.S. Pat. No. 3,859,527 are “SrS:Ce, Sm”, “SrS:Eu, Sm”, “ThO₂:Er”, and “La₂O₂S:Eu, Sm”.

JP 55-12142 A discloses “ZnS:Cu, Pb”, “BaO.xAl₂O₃:Eu (0.8≦x≦10)”, and stimulable phosphors represented by the general formula “M^{II}O.xSiO₂:A”. In this formula, M^{II} is at least one element selected from the group consisting of Mg, Ca, Sr, Zn, Cd, and Ba, A is at least one element selected from the group consisting of Ce, Tb, Eu, Tm, Pb, Tl, Bi, and Mn, and 0.5≦x≦2.5.

Stimulable phosphors represented by the general formula “LnOX:xA” are disclosed by JP 55-12144 A. In this formula, Ln is at least one element selected from the group consisting of La, Y, Gd, and Lu, X is at least one element selected from Cl and Br, A is at least one element selected from Ce and Tb, and 0≦x≦0.1.

Stimulable phosphors represented by the general formula “(Ba₁₋ₓ, M²⁺ₓ)FX:yA” are disclosed by JP 55-12145 A. In this formula, M²⁺ is at least one element selected from the group consisting of Mg, Ca, Sr, Zn, and Cd, X is at least one element selected from Cl, Br, and I, A is at least one element selected from Eu, Tb, Ce, Tm, Dy, Pr, Ho, Nd, Yb, and Er, 0≦x≦0.6, and 0≦y≦0.2.

JP 59-38278 A discloses stimulable phosphors represented by the general formula “xM₃(PO₄)₂.NX₂:yA” or “M₃(PO₄)₂.yA”. In this formula, M and N are each at least one element selected from the group consisting of Mg, Ca, Sr, Ba, Zn, and Cd, X is at least one element selected from F, Cl, Br, and I, A is at least one element selected from Eu, Tb, Ce, Tm, Dy, Pr, Ho, Nd, Yb, Er, Sb, Tl, Mn, and Sn, 0≦x≦6, and 0≦y≦1.

Stimulable phosphors are represented by the general formula “nReX₃.mAX′₂:xEu” or “nReX₃.mAX′₂:xEu, ySm”. In this formula, Re is at least one element selected from the group consisting of La, Gd, Y, and Lu, A is at least one element selected from Ba, Sr, and Ca, X and X′ are each at least one element selected from F, Cl, and Br, 1×10⁻⁴<x<3×10⁻¹, 1×10⁻⁴<y<1×10⁻¹, and 1×10⁻³<n/m<7×10⁻¹.

Alkali halide-based stimulable phosphors represented by the general formula “M^{I}X.aM^{II}X′₂.bM^{III}X″₃:cA” are disclosed by JP 61-72087 A. In this formula, M^{I} represents at least one element selected from the group consisting of Li, Na, K, Rb, and Cs. M^{II} represents at least one divalent metal selected from the group consisting of Be, Mg, Ca, Sr, Ba, Zn, Cd, Cu, and Ni. M^{III} represents at least one trivalent metal selected from the group consisting of Sc, Y, La, Ce, Pr, Nd, Pm, Sm, Eu, Gd, Tb, Dy, Ho, Er, Tm, Yb, Lu, Al, Ga, and In. X, X′, and X″ each represent at least one element selected from the group consisting of F, Cl, Br, and I. A represents at least one element selected from the group consisting of Eu, Tb, Ce, Tm, Dy, Pr, Ho, Nd, Yb, Er, Gd, Lu, Sm, Y, Tl, Na, Ag, Cu, Bi, and Mg, 0≦a<0.5, 0≦b<0.5, and 0<c≦0.2.

Stimulable phosphors represented by the general formula “(Ba₁₋ₓ, M^{II}ₓ)F₂.aBaX₂:yEu, zA” are disclosed by JP 56-116777 A. In this formula, M^{II} is at least one element selected from the group consisting of Be, Mg, Ca, Sr, Zn, and Cd, X is at least one element selected from Cl, Br, and I, A is at least one element selected from Zr and Sc, 0.5≦a≦1.25, 0≦x≦1, 1×10⁻⁶≦y≦2×10⁻¹ and 0<z≦1×10⁻².

Stimulable phosphors represented by the general formula “M^{III}OX:xCe” are disclosed by JP 58-69281 A. In this formula, M^{III} is at least one trivalent metal selected from the group consisting of Pr, Nd, Pm, Sm, Eu, Tb, Dy, Ho, Er, Tm, Yb, and Bi, X is at least one element selected from Cl and Br, and 0≦x≦0.1.

Stimulable phosphors represented by the general formula “Ba₁₋ₓMₐLₐFX:yEu²⁺” are disclosed by JP 58-206678 A. In this formula, M is at least one element selected from the group consisting of Li, Na, K, Rb, and Cs, L is at least one trivalent metal selected from the group consisting of Sc, Y, La, Ce, Pr, Nd, Pm, Sm, Gd, Tb, Dy, Ho, Er, Tm, Yb, Lu, Al, Ga, In, and Tl, X is at least one element selected from Cl, Br, and I, 1×10⁻²≦x≦0.5, 0≦y≦0.1, and a is x/2.

Stimulable phosphors represented by the general formula “M^{II}FX.aM^{I}X′.bM′^{II}X″₂.cM^{III}X₃.xA:yEu²⁺” are disclosed by JP 59-75200 A. In this formula, M^{II} is at least one element selected from the group consisting of Ba, Sr, and Ca, M^{I} is at least one element selected from Li, Na, K, Rb, and Cs, M′^{II} is at least one divalent metal selected from Be and Mg, M^{III} is at least one trivalent metal selected from the group consisting of Al, Ga, In, and Tl, A is a metal oxide, X, X′, and X″ are each at least one element selected from the group consisting of F, Cl, Br, and I, 0≦a≦2, 0≦b≦1×10⁻², 0≦c≦1×10⁻², and a+b+c≧10⁻⁶, 0<x≦0.5, and 0<y≦0.2.

Alkali halide-based stimulable phosphors disclosed by JP 61-72087 A are preferred because they have excellent photostimulated luminescence characteristics and the effects of the present invention are advantageously obtained. Alkali halide-based stimulable phosphors in which M^{I} contains at least Cs, X contains at least Br, and A is Eu or Bi are more preferred, with a stimulable phosphor represented by the general formula “CsBr:Eu” being particularly preferred.

The vacuum chamber 12 of the embodiment under consideration may be any known vacuum chamber (e.g. bell jar or vacuum vessel) that is formed of iron, stainless steel, aluminum, etc. and which is employed in apparatuses for vacuum evaporation.

The vacuum pump 18 is connected to a lateral surface 12b of the vacuum chamber 12 through a diffuser 18a. For example, an oil diffusion pump is used for the vacuum pump 18. Various types as used in vacuum evaporation apparatuses may be employed for the vacuum pump 18 without any particular limitation as long as a requisite ultimate degree of vacuum can be attained. For example, a cryogenic pump and a turbo-molecular pump may be used optionally in combination with a cryogenic coil. In the production apparatus 10 intended to form the phosphor layer, the ultimate degree of vacuum to be attained in the vacuum chamber 12 is preferably 8.0×10⁻⁴ Pa or higher.

A lateral surface 12c of the vacuum chamber 12 opposite from the lateral surface 12b has a door 13 that may be opened as desired.

In this embodiment, the door 13 is opened to carry the substrate 70 and the film-forming materials into the vacuum chamber 12. The door 13 is shut to close the vacuum chamber 12 to carry out vacuum evaporation.

The gas introducing nozzle 19 is also a known gas-introducing means that has a means of connection to a cylinder as well as a means for regulating the gas flow rate (the nozzle may alternatively be connected to those means), and which is conventionally employed in apparatuses for vacuum evaporation, sputtering, etc. In order to form a phosphor layer by vacuum evaporation under the medium degree of vacuum, an inert gas or rare gas such as argon or nitrogen gas is introduced into the vacuum chamber 12 through the nozzle 19. The inert gas is a gas that does not react with the materials of the substrate 70 and the phosphor layer during vacuum evaporation.

The inert gas is introduced into the vacuum chamber 12 through an opening (gas introduction opening) 19a of the gas introducing nozzle 19. The gas introducing nozzle 19 (or its opening 19a) is provided in a bottom surface 12a of the vacuum chamber 12 in the vicinity of the thermal evaporating section 16.

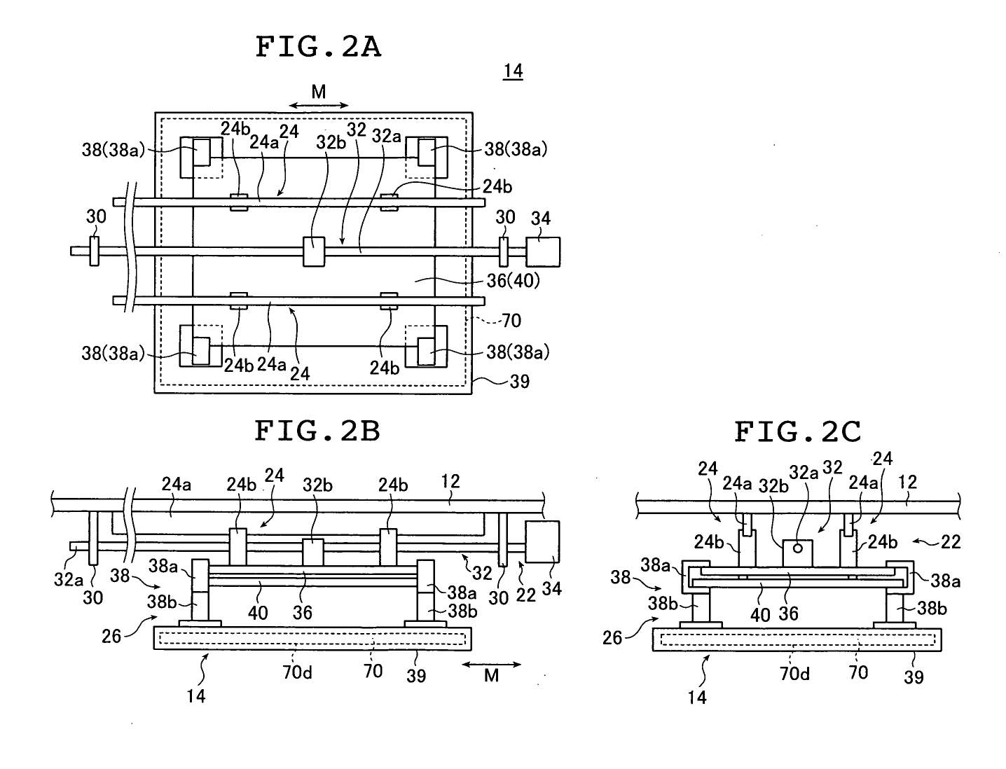

The substrate holding and transporting mechanism 14 holds the substrate holder 39 into which the substrate 70 is inserted and linearly transports it. As schematically shown in FIGS. 2A-2C, the substrate holding and transporting mechanism 14 includes a drive means 22, two linear motor guides 24 and a substrate holding means 26. FIGS. 2A, 2B and 2C are, respectively, a plan view, a front view and a side view schematically showing the substrate holding and transporting mechanism 14 of the apparatus for producing radiation image conversion panels as shown in FIG. 1A.

The drive means 22 is used to move the substrate holding means 26 to and fro in directions M in which the substrate 70 is transported. The drive means 22 is a known mechanism for effecting linear movement by making use of a ball screw, and includes a ball screw 32 having a screw shaft 32a which extends in the directions of transport M of the substrate 70 and axially supported by holding members 30 to be rotatable and a nut 32b engaged with the screw shaft 32a, and a motor 34 for rotating the screw shaft 32a.

The drive means making use of the ball screw 32 and the motor 34 is not the sole case of the present invention, but various other known means for linear movement (transport) as exemplified by a transport means using a cylinder, and a transport means using a motor and a ring-like chain rotated by the motor may be used as long as the transport means used has required thermal resistance.

The linear motor guides (hereinafter referred to as the “LM guides”) 24 are known linear motor guides assisting the linear transport of the substrate holding means 26 (i.e., the substrate 70) by means of the drive means 22, and each include a guide rail 24a and two engaging members 24b engaged with the guide rail 24a so as to be movable in the longitudinal direction.

The two guide rails 24a extend in the directions of transport M of the substrate 70, and are spaced apart from each other with respect to the screw shaft 32a and fixed to the ceiling of the vacuum chamber 12. On the other hand, the four engaging members 24b are fixed to the substrate holding means 26 (upper surface of a base 36 to be described later) such that two of the engaging members 24b are engaged with one of the guide rails 24a.

The substrate holding means (hereinafter also referred to simply as the “holding means”) 26 which holds the substrate 70 accommodated in the substrate holder 39 is linearly moved by the drive means 22 while being guided by the LM guides 24. The substrate holding means 26 includes the base 36, a holding mechanism 38 and a heat insulating member 40.

The base 36 is a rectangular plate which is horizontal when the production apparatus 10 is properly installed.

The nut 32b of the ball screw 32 is fixed to the upper surface of the base 36 at its center. The engaging members 24b of the LM guides 24 are fixed to the upper surface of the base 36 at symmetrical positions on the two diagonals as determined by the distance between the two guide rails 24a.

The holding means 38 includes four attachment members 38a and four holding members 38b, which are disposed at corners of the base 36, respectively.

The attachment member 38a is a member having a substantially C-shaped section. The attachment member 38a is inserted from the outside in a direction perpendicular to the directions of transport M with the open side in the C-shaped section directed inward such that part of the upper portion in the C-shaped member is attached at the corner of the base 36. The attachment member 38a is thus fixed to the base 36 so as to be suspended therefrom. Therefore, a larger space than the area of the base 36 is provided below the base 36 of the holding means 26.

The holding member 38b has at its lower end a means for holding the substrate holder 39 (substrate 70) and is fixed to the attachment member 38a so as to be suspended therefrom. In other words, the holding mechanism 38 for holding the substrate holder 39 (substrate 70) is suspended from the base 36 in the vicinities of its corners.

In the embodiment under consideration, there is no particular limitation on the method of holding the substrate holder 39 (substrate 70) with the holding members 38b, but various known methods of holding a plate from its upper surface side such as a method using a tool, a method using static electricity, and a method using suction may be employed. If the region of the substrate 70 where the phosphor layer is to be vapor-deposited permits, a means for holding four corners or four sides of the substrate holder 39 (substrate 70) from below by using a tool or the like may be employed.

A method in which a spacer is inserted between the attachment member 38a and the holding member 38b, a method in which an adjusting means using screws is provided, and a method in which an ascending/descending means depending on a cylinder is provided may be employed such that the lower end position of the holding member 38b, that is, the height at which the substrate 70 is held and transported can be adjusted.

As described above, the base 36 is linearly transported by the drive means 22. Therefore, in the substrate holding and transporting mechanism 14, the holding means 26 is transported by the drive means 22 while the holding mechanism 38 holds the substrate holder 39 (substrate 70), for example, in the vicinities of the four corners, whereby the substrate 70 is linearly transported together with the substrate holder 39.

The phosphor layer of the radiation image conversion panel intended to read a radiation image with a line sensor or the like requires uniformity in the film thickness distribution as high as within ±3% and preferably within ±2%.

In the embodiment under consideration, the phosphor layer is formed by vacuum evaporation under the medium degree of vacuum through resistance heating while the substrate 70 is linearly transported as described above, whereby the phosphor layer formed has excellent crystallinity and is highly uniform in film thickness distribution.

When the phosphor layer of any one of the aforementioned various stimulable phosphors which is advantageously formed by the production process of the present invention, particularly the phosphor layer of an alkali halide-based stimulable phosphor, and more particularly the phosphor layer of a stimulable phosphor represented by CsBr:Eu is to be formed by vacuum evaporation, a preferred procedure includes first evacuating the system to a high degree of vacuum, then introducing an inert gas such as argon gas or nitrogen gas into the system with continued evacuation to achieve a degree of vacuum between about 0.1 Pa and about 10 Pa and particularly about 0.5 Pa and about 3 Pa, thereby forming the phosphor layer under such medium degree of vacuum.

The thus formed phosphor layer has a satisfactory columnar crystal structure, which enables a radiation image conversion panel produced to have satisfactory photostimulated luminescence characteristics and provide excellent image sharpness.

The production apparatus 10 of this embodiment basically forms the phosphor layer under such medium degree of vacuum, and vacuum evaporation is carried out through resistance heating under the medium degree of vacuum while introducing an inert gas into the vacuum chamber 12 through the gas introducing nozzle 19 (its opening 19a).

In the production apparatus 10 of this embodiment, the phosphor layer is formed by vacuum evaporation while the substrate 70 is linearly transported in the state in which it is accommodated in the substrate holder 39, so the speed of movement of the substrate 70 can be made uniform over the whole surface thereof.

More specifically, the substrate 70 can be uniformly exposed to vapors of the film-forming materials over the entire surface merely by making uniform the amounts of the film-forming materials evaporated in a direction H perpendicular to the directions of transport M. The phosphor layer with highly uniform film thickness distribution can also be formed by simply setting the positions of the evaporation sources. In addition, film deposition during the transport by linear reciprocation enables europium (activator) which is a trace component to be suitably dispersed in the phosphor layer.

In the present invention, as long as the phosphor layer having a required thickness can be formed, film deposition may be carried out during one linear movement, or one or more reciprocating movements of the substrate 70. The substrate may be transported along a more or less zigzag or undulating path as long as the path is substantially linear.

In general, given the same thickness, the greater the number of passes over the thermal evaporating section 16, the higher the uniformity that can be attained in thickness distribution; hence, it is preferred to form a phosphor layer by reciprocating the substrate a plurality of times. The number of reciprocating movements may be determined as appropriate for the desired thickness of the phosphor layer, the desired uniformity in the film thickness distribution, and other factors, and the last transport may be made only in one direction. The speed in the linear transport may also be determined as appropriate for the limits of transport speed that are rated for the LM guides, the number of reciprocating movements, the desired thickness of the phosphor layer, and other factors.

In the holding means 26 for holding the substrate holder 39 (substrate) 70, the heat insulating member 40 is provided under the base 36 to the upper surface of which the nut 32b of the ball screw 32 and the engaging members 24b of the LM guides 24 are fixed. As described above, the production apparatus 10 of the illustrated case uses the substantially C-shaped attachment members 38a to fix the holding members 38b in a state in which the holding members 38b are suspended from the base 36, thereby providing a larger space under the base 36 than in the base 36. In the illustrated embodiment, this layout enables the heat insulating member 40 to have a larger area than that of the substrate 36 to entirely cover the lower surface of the base 36 with a sufficient margin.

The heat insulating material 40 shields the base 36 against the thermal evaporating section 16 (evaporation sources) to be described later to keep the engaging members 24b of the LM guides 24 and the nut 32b of the ball screw 32 from being heated due to heat of radiation from the thermal evaporating section 16.

As is clear from the above description, it is necessary to perform vacuum evaporation through resistance heating under the medium degree of vacuum as the substrate holder 39 (substrate 70) is linearly transported, in order to produce the radiation image conversion panel that has a sufficient crystal structure to achieve high photostimulated luminescence characteristics and image sharpness and a sufficiently high uniformity in film thickness to enable high-precision reading of radiation image with a line sensor.

As is well known, a ball is incorporated into each of the engaging members 24b of the LM guides 24 and the nut 32b of the ball screw 32 to enable smooth movement and a lubricant such as grease is injected thereinto to enable smooth rotation of the ball. Even in the case where no ball is used, a lubricant such as grease is usually injected into the sliding portions of the drive means and a transport guide means to enable smooth driving.

Various members may be used for the heat insulating member 40 without any particular limitation as long as the engaging members 24b and the nut 32b and optionally the base 36 are shielded against the heat of radiation from the thermal evaporating section 16 to be prevented from being heated. Exemplary members that may be used include a stainless steel plate, a steel plate, an aluminum plate, and a molybdenum plate. The fixing method may be determined as appropriate for the heat insulating member 40 used.

Means for cooling the heat insulating member 40 such as a means in which cooling water is allowed to flow through a pipe contacting the heat insulting member 40, and a means in which water is allowed to flow through a hole formed in the plate (heat insulating member 40) may be provided as required.

As described above, in the illustrated preferable embodiment, the heat insulating member 40 has a larger area than the base 36 and is disposed so as to cover the whole lower surface of the base 36 to which the engaging members 24b of the LM guides 24 and the nut 32b of the ball screw 32 are fixed. However, this is not the sole case of the present invention and the regions corresponding to the engaging members 24b of the LM guides 24 or the region corresponding to the nut 32b of the ball screw 32 may only be covered with a member for insulating against the thermal evaporating section 16.

Nevertheless, in order to advantageously prevent the engaging members 24b and the nut 32b from being heated, it is preferable to cover a member that may transmit heat to these components with the heat insulating member 40 to insulate them against the thermal evaporating section 16 as much as possible.

Referring to FIGS. 1A and 1B again, the thermal evaporating section 16 is provided in the lower part of the vacuum chamber 12.

The thermal evaporating section 16 is a site where the film-forming materials such as cesium bromide and europium bromide to form the phosphor layer are evaporated by resistance heating. The film-forming materials are heated to evaporate in the thermal evaporating section 16 to form the vapor deposition area including vapors of cesium bromide and europium bromide (film-forming materials in the form of vapor).

As described above, the production apparatus 10 preferably performs two-source vacuum evaporation in which cesium bromide as the phosphor component and europium bromide as the activator component are independently heated to evaporate. Therefore, the thermal evaporating section 16 is provided with crucibles (vessels) 50 serving as evaporation sources of cesium bromide (phosphor) and crucibles (vessels) 52 serving as evaporation sources of europium bromide (activator).

Like crucibles employed in ordinary vacuum evaporation that depends on resistance heating, the crucibles 50 and 52 are formed of high-melting point metals such as tantalum (Ta), molybdenum (Mo) and tungsten (W) and supplied with electricity from electrodes (not shown) to generate heat by themselves so that the film-forming materials with which the crucibles are filled are heated/melted to evaporate.

In the present invention, the power supply for resistance heating (heating control means) is not particularly limited but various systems as used in resistance heating devices may be used as exemplified by a thyristor system, a DC system, and a thermocouple feedback system. There is also no particular limitation on the power to be output in resistance heating, but the power may be determined as appropriate for the film-forming material used, electric resistance of the film-forming material in the crucible, and the amount of heat generated.

In the storage phosphor, the proportions of the activator and the phosphor are such that the greater part of the phosphor layer is assumed by the phosphor, as exemplified by a molarity ratio ranging from about 0.0005/1 to about 0.01/1.

Therefore, in the illustrated case, a cylindrical (drum-shaped) large crucible is used for the crucible 50 from which cesium bromide (phosphor) is evaporated (consumed) in a large amount. The crucible 50 has a slit opening that is provided on the lateral surface of the drum-shaped crucible so as to extend parallel to the axis of the drum-shaped crucible. A chimney 50a in the shape of a quadrangular prism is fixed at the opening as a vapor-emitting portion. The chimney has an upper and a lower opening which has the same shape as that of the slit opening.

On the other hand, a crucible type evaporation source for vacuum evaporation CE-2 manufactured by Japan Vacs Metal Co., Ltd. is used for the crucible 52 from which europium bromide (activator) is evaporated (consumed) in a small amount. Tantalum is used for the material of the crucible. The crucible has a structure in which the outer periphery of the tantalum member is covered with a heater whose outer periphery is then covered with alumina as a heat insulating material. The crucible is heated by an indirect heating system.

An advantage of the crucibles having such slit-like chimneys is that when bumping occurs on account of local heating or abnormal heating in the crucibles, abrupt gushing of the film-forming materials from within the crucibles and the adhesion of the gushed film-forming materials to the surrounding area and the substrate 70 can be prevented, thus ensuring that there will be no contamination of the surrounding areas and the substrate 70. The beneficial effect of this feature is particularly significant when vacuum evaporation is performed by resistance heating under the medium degree of vacuum, because there is a need to bring the substrate 70 close enough to the evaporation sources as described above.

In the production apparatus 10, the crucibles 50 and the crucibles 52 are arranged in a plurality of rows in the direction H perpendicular to the directions of transport M of the substrate 70 (hereinafter the direction H is referred to as the “direction of arrangement H”) to make the amounts of the film-forming materials evaporated uniform in the direction of arrangement H such that the vapors of the film-forming materials are uniformly supplied to the whole surface of the substrate 70 being linearly transported, thus forming a phosphor layer in which the uniformity in the thickness distribution is, for example, within ±3%. The crucibles are thermally insulated from each other by spacing them apart from each other or inserting an insulating material in the spaces between adjacent crucibles.

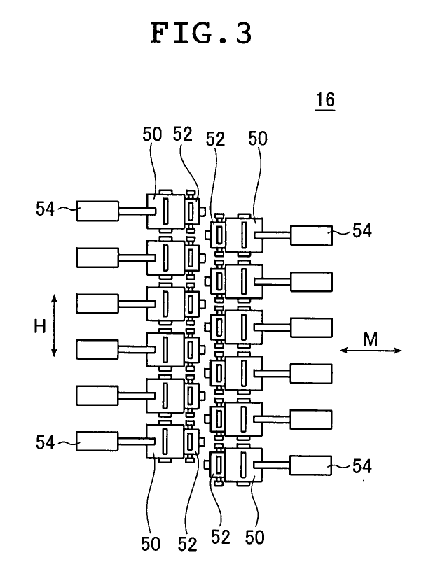

FIG. 3 shows a schematic plan view of the thermal evaporating section 16. In the example shown in FIG. 3, the crucibles 50 for cesium bromide are arranged in the direction of arrangement H parallel to the axial direction of the cylinder (drum) and the number of the crucibles 50 arranged is six. Each of the crucibles 50 has electrodes which are formed at the end faces of the cylinder and independently connected to the power supply. A quartz crystal sensor 54 for measuring the amount of cesium bromide evaporated is provided for each of the crucibles 50 (not shown in FIGS. 1A and 1B for clarifying the entire layout of the apparatus). The amount of current to be applied to the crucible 50 is controlled based on the measurement result of the amount of evaporation. The amount of evaporation may be controlled with a temperature sensor.

On the other hand, the crucibles 52 for europium bromide are boat-type crucibles and are arranged with the longitudinal direction in agreement with the direction of arrangement H. The number of the crucibles 52 is also six. Each of the crucibles 52 has electrodes which are formed at both ends in the direction of arrangement H and independently connected to the power supply.

In the illustrated preferred embodiment, one crucible 50 and one crucible 52 make a pair, in other words, one evaporation source for cesium bromide which is the film-forming material as the phosphor component and one evaporation source for europium bromide which is the film-forming material as the activator component make a pair, and the two crucibles in the pair are arranged to align in the directions of transport M of the substrate M. The crucibles in the pair are more preferably disposed so as to be the closest possible to each other in terms of the layout of the apparatus and crucibles.

Such a layout enables the vapor of europium bromide to be fully dispersed in the vapor of cesium bromide constituting the matrix so that europium (activator) which is a trace component is uniformly dispersed in the phosphor layer, and the thus formed phosphor layer can be excellent in photostimulated luminescence and other characteristics.

With regard to the row of the crucibles 50 and the row of the crucibles 52, in terms of the layout of the apparatus and crucibles, it is preferable that the crucibles in one row be arranged in the direction of arrangement H so as to be the closest possible to each other and that the crucible row have enough length to cover the size of the substrate 70 in the direction of arrangement H.

Such a layout enables the amounts of vapors of the film-forming materials to be made uniform in the direction of arrangement H, thus forming a phosphor layer having higher uniformity in film thickness distribution.

The crucibles for each film-forming material may be arranged in the direction of arrangement H in one row, in two rows as in the illustrated case, or in three or more rows.

In the case where there are two or more crucible pair rows, each crucible pair row is preferably arranged such that, when viewed from the directions of transport M of the substrate 70, outlets of the vapors of the film-forming materials (the abovementioned slit-like chimneys) in one crucible pair row fill the gaps between adjacent vapor outlets of the adjacent crucible pair row in the direction of arrangement H. It is more preferable to arrange the crucible pair rows such that the outlets of the vapors of the film-forming materials in different crucible pair rows do not overlap each other when viewed from the directions of transport M. In other words, it is preferable for the outlets of the vapors of the film-forming materials in the respective crucible pair rows to be arranged in a staggered manner when viewed from the directions of transport M. In the illustrated case, the two crucible pair rows are arranged in the direction of arrangement H such that, when viewed from the directions of transport M, the vapor outlets in one crucible pair row are disposed at the positions corresponding to the positions where the other crucible pair row has the electrodes.

Such a layout enables the amounts of vapors of the film-forming materials to be made uniform in the direction of arrangement H, thus forming a phosphor layer having higher uniformity in film thickness distribution.

In the case where there are two or more crucible pair rows in the direction of arrangement H, it is preferable for the rows of crucibles 50 from which a large amount of cesium bromide (phosphor) evaporates to be disposed outside with respect to the directions of transport M.

In such a layout, the sensors 54 for detecting the amount of cesium bromide evaporated in a large amount can be disposed in the space outside the crucible pair rows with respect to the directions of transport M. In other words, it is possible to increase the degree of flexibility in selecting the sensor for detecting the amount of evaporation and in designing the production apparatus 10.

Although not shown, in the thermal evaporating section 16 of the production apparatus 10, a quadrangular prism-shaped heat insulating member having a height exceeding the uppermost portions of the crucibles is disposed so as to surround all the crucibles from the four horizontal directions. The upper side of the heat insulating member is provided with a shutter (not shown) for shielding the substrate against the vapors of the film-forming materials and can be closed or opened as desired by means of the shutter.

In the embodiment under consideration, the substrate 70 is a thin plate member or a sheet member made of, for example, a metal or an alloy. The material of the substrate 70 is not particularly limited but, for example, aluminum, aluminum alloy, iron, stainless steel, copper, chromium or nickel may be used. The substrate 70 in this embodiment is preferably made of aluminum or an aluminum alloy.

All types of materials for sheet-shaped substrates used in radiation image conversion panels such as glass, ceramics, carbon, PET (polyethylene terephthalate), PEN (polyethylene naphthalate), and polyamide may be used for the substrate 70.

Next, the steps of the radiation image conversion panel production process in an embodiment of the invention that uses the production apparatus 10 are described in detail.

In the radiation image conversion panel production process of the embodiment under consideration, a radiation image conversion panel 80 as shown in FIG. 6 that includes a substrate 70, a phosphor layer 72 formed on the substrate 70, and a moisture-proof protective layer 74 formed on the phosphor layer 72 to hermetically seal it is finally produced. In the previous step, the phosphor layer 72 is first formed on the substrate 70.

The substrate 70 is set in advance in the substrate holder 39 (see FIG. 1A).

Then, the substrate 70 accommodated in the substrate holder 39 is set in a plasma cleaner (not shown) to perform plasma cleaning of the surface 70d of the substrate 70 on which the phosphor layer 72 is to be formed.

Then, the door 13 of the vacuum chamber 12 is opened to the atmosphere, and the substrate holder 39 containing the substrate 70 is held by the holding members 38b of the holding means 26 (see FIG. 2B) of the substrate holding and transporting mechanism 14.

Then, all the crucibles 50 are loaded with a predetermined amount of cesium bromide whereas all the crucibles 52 are loaded with a predetermined amount of europium bromide, in other words, the film-forming materials are set in the vacuum chamber 12; thereafter, the shutter (not shown) is closed.

Then, the vacuum pump 18 is activated to evacuate the vacuum chamber 12; at the time when the pressure in the vacuum chamber 12 has reached a predetermined value, say, 8×10⁻⁴ Pa, for example, argon gas is introduced into the vacuum chamber 12 through the opening 19a of the gas introducing nozzle 19 with the evacuating process being continued such that the pressure in the vacuum chamber 12 is adjusted to, for example, 1.0 Pa; thereafter, the power supply for resistance heating is turned on so that an electric current is applied to all the crucibles 50 and 52 to heat the film-forming materials.

After the lapse of a preset period of time (e.g., 60 minutes), the shutter is opened; then, the motor 34 is driven to start linear transport of the substrate 70 at a predetermined speed to thereby start the formation of the phosphor layer 72 on the surface 70d of the substrate 70.

When a specified number of reciprocating movements of the substrate 70 for its linear transport as determined in accordance with such factors as the thickness of the phosphor layer 72 to be formed have completed, the substrate 70 is brought to a stop, the shutter is closed, the power supply for resistance heating is turned off, and the supply of argon gas through the gas introducing nozzle 19 is stopped.

Then, nitrogen gas or dry air is introduced into the vacuum chamber 12 to restore the atmospheric pressure; that is, the vacuum chamber 12 is opened to the atmosphere.

Then, the door 13 of the vacuum chamber 12 is opened to take out the substrate 70 having the phosphor layer 72 formed thereon, with the substrate 70 accommodated in the substrate holder 39, and carry it to the workbench.

As described above, the characteristic operation in the radiation image conversion panel production process in this embodiment is to attach a selectively permeable cover such as a dust-proof cover to the substrate 70 on which the phosphor layer 72 has been formed, in other words, the phosphor sheet (substrate having the phosphor layer formed thereon) until the end of a thermal treatment.

The selectively permeable cover is used to prevent adhesion of foreign matter such as dirt and dust while the whole surface of a phosphor sheet is kept under uniform temperature and humidity conditions. Any cover can be used as the selectively permeable cover as long as it has the above-described function. Preferred examples of the selectively permeable cover include a dust-proof cover. As the dust-proof cover, for example, an aluminum plate that has a large number of fine pores formed therein and has supporting legs for holding the plate so as not to contact the surface of the phosphor sheet may be advantageously used.

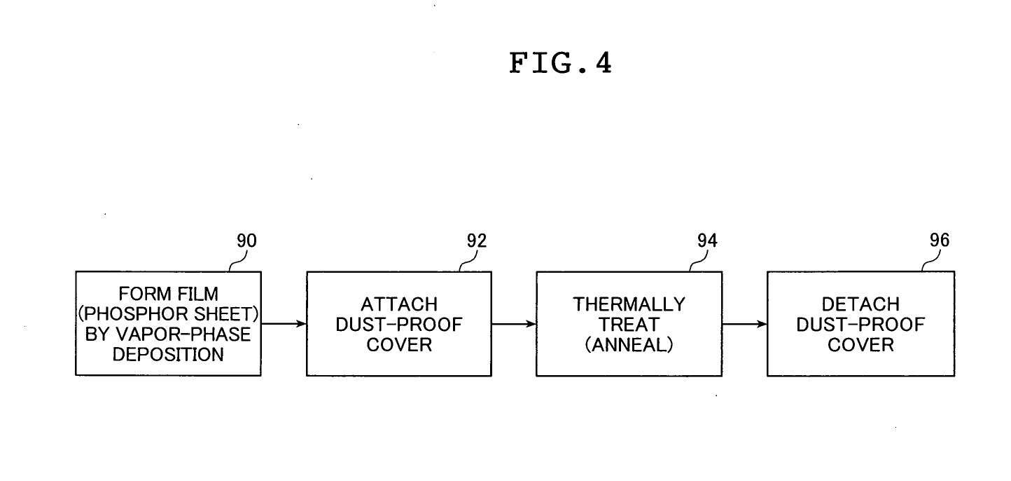

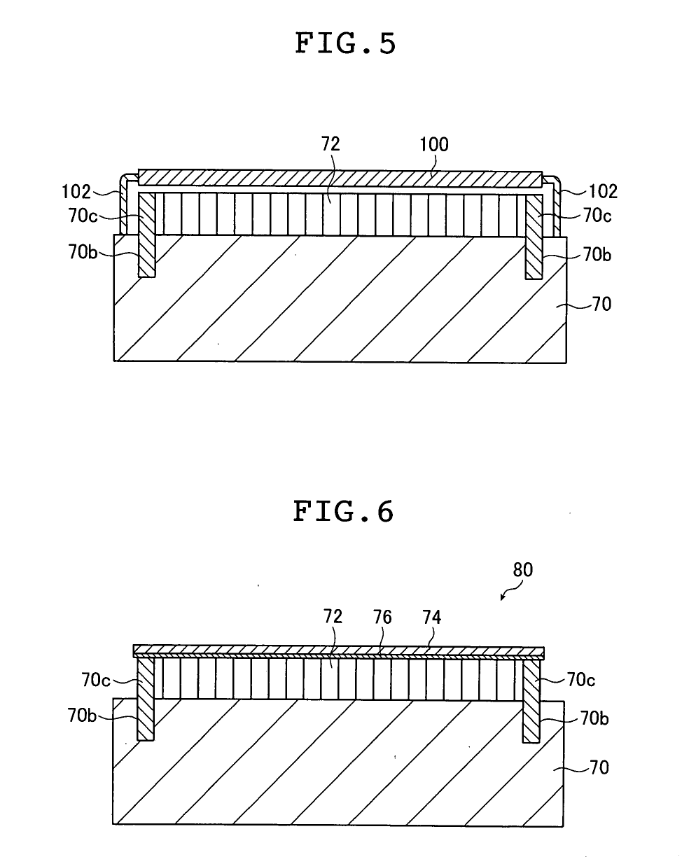

To be more specific, as shown in FIG. 4, upon formation of a phosphor sheet (Step 90), the phosphor sheet is detached from the substrate holder 39 and a dust-proof cover 100 (see FIG. 5) is attached to the upper side of the phosphor sheet (Step 92). A predetermined thermal treatment (annealing) is performed in a thermal treatment unit (Step 94). After the end of the thermal treatment, the dust-proof cover is detached (Step 96).

It is preferable to perform a humidification step prior to the thermal treatment (annealing) in the thermal treatment unit. This step will be described later in further detail.

An aluminum plate having a large number of fine pores with a diameter of 20 μm formed therein was used for the dust-proof cover. The dust-proof cover 100 is preferably designed as shown in FIG. 5 according to which the dust-proof cover 100 has supporting legs 102 of any appropriate shape and is positioned in such a manner that its bottom surface does not contact the surface of the phosphor sheet (phosphor layer 72). A frame 70c in FIG. 5 defines the area where the phosphor layer 72 is vapor-deposited (see FIG. 6).

The step of enhancing the sensitivity to irradiation by keeping the phosphor sheet under predetermined temperature and humidity conditions is optionally added to the production process after the formation of the phosphor sheet but before the start of the thermal treatment. As will be described later in detail, fine pores are formed in the dust-proof cover to prevent adhesion of foreign matter such as dust and dirt in the sensitivity-enhancing step in which the whole surface of the phosphor sheet is kept under the uniform temperature and humidity conditions. The pore size may be determined based on the experimental results but is preferably from 1 μm to 1.5 mm (1,500 μm) in the present invention in order to prevent the phosphor sheet (radiation image conversion panel) from having stains due to foreign matter such as dirt and dust.

The aluminum plate having the fine pores with a predetermined size is used, but this is not the sole case of the present invention. A ready-made, so-called porous material such as a woven metal wire or a sintered body may also be selected as appropriate.

The radiation image conversion panel production process in the embodiment under consideration in which the dust-proof cover is attached to the formed phosphor sheet until the end of the thermal treatment can prevent foreign matter such as dirt and dust from adhering to the phosphor sheet, leading to prevention of staining (discoloration) due to the adhering dirt and dust, and consequently has an effect of obtaining a radiation image free of point defects from the radiation image conversion panel.

As described above, the sensitivity to irradiation can be enhanced by keeping the phosphor sheet after the end of vapor deposition under predetermined temperature and humidity conditions. The inventors of the present invention have quantitatively caught this phenomenon, which afforded a clue to a specific application for enhancing the sensitivity of the phosphor sheet to irradiation.

The reference temperature and humidity conditions deemed to be practically effective are to keep the phosphor sheet for 5 minutes to 1 week in an environment of 20° C. to 50° C. and 30 to 80% RH. It is deemed that these conditions may be influenced by the type of a phosphor constituting the phosphor sheet, conditions of vapor deposition, and conditions of thermal treatment after the phosphor sheet has been kept in the above-defined environment.

The radiation image conversion panel production process in the embodiment under consideration has a characteristic feature that the phosphor sheet is protected by the selectively permeable cover in the process from the end of the vapor deposition to the end of the thermal treatment. However, the present invention may be implemented in a different embodiment.

To be more specific, another embodiment may be implemented which includes a step of removing foreign matter such as dirt and dust adhering to the surface of the phosphor layer having been formed by the vapor deposition before the thermal treatment is started, instead of the step of attaching the cover described above to the phosphor sheet.

Inclusion of such step enables the surface of the phosphor layer to be free of dirt and dust at the start of the thermal treatment, and has consequently an effect of obtaining a radiation image having no point defects from the radiation image conversion panel.

The steps of the radiation image conversion panel production process of this embodiment is described below in further detail with reference to a radiation image conversion panel produced by using the production apparatus 10.

The step of the vapor deposition using the production apparatus 10 in the radiation image conversion panel production process is the same as described above, so a description is given below of the step of removing foreign matter such as dirt and dust from the thus formed radiation image conversion panel (phosphor layer).

In the step of removing foreign matter such as dirt and dust in the radiation image conversion panel production process of the embodiment under consideration, dirt and dust that may adhere to the surface of the phosphor layer after the end of the vapor deposition are removed before starting the thermal treatment to prevent the dirt and dust from being subjected to the thermal treatment.

Exemplary methods that may be specifically employed for removal include various methods such as a non-contact method (e.g., a removal method by means of air blowing) and a contact method (e.g., a removal method using an adhesive material).

The firstly illustrated non-contact method is described below with reference to the removal method by means of air blowing.

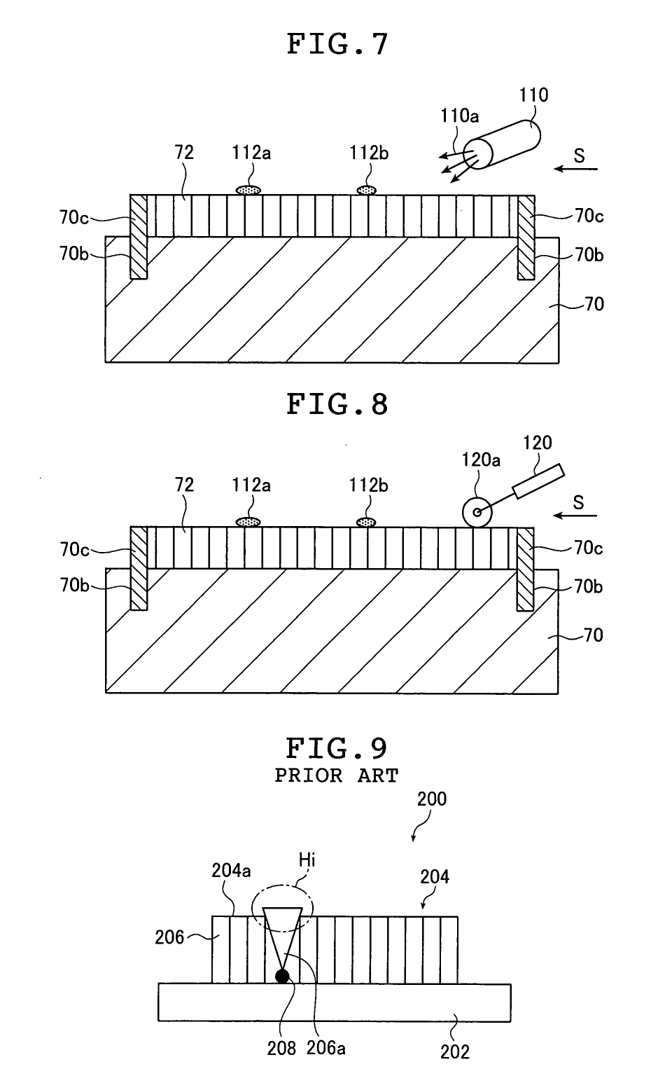

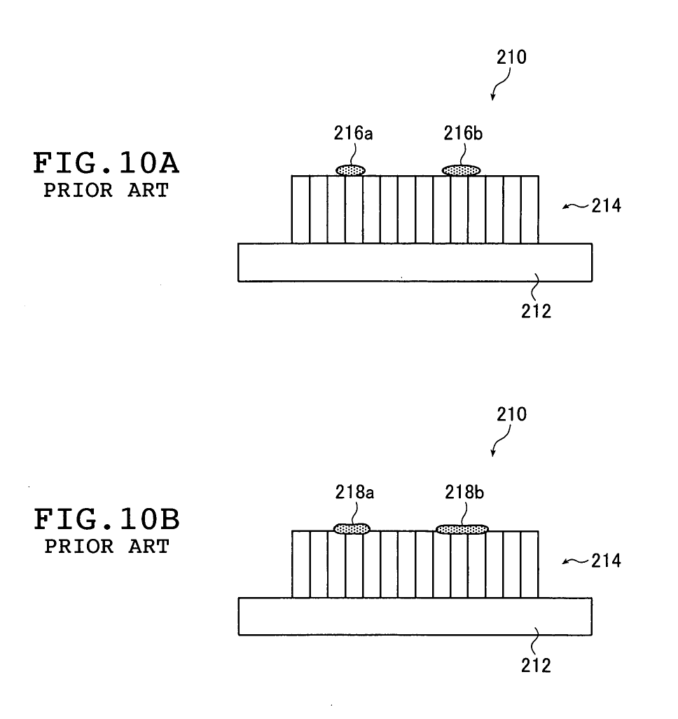

A method is applicable which uses an apparatus that moves an air gun (air injection gun) 110 as shown in FIG. 7 capable of blowing a predetermined amount of air 110a at a predetermined rate from one end to the other end of the phosphor layer 72 as indicated by an arrow S of FIG. 7 to thereby remove pieces of dirt 112a, 112b on the phosphor layer 72. The rate of air blown in the present invention is not particularly limited and is preferably at least 2 m/s in order to prevent the phosphor sheet (radiation image conversion panel) from having stains due to foreign matter such as dirt and dust.

Another method may be applied in which a dirt removing roller 120 as shown in FIG. 8 equipped with a roller 120a having an adhesive material applied thereto (hereinafter referred to as an “adhesive roller”) is moved as above in the direction indicated by the arrow S of FIG. 8 to remove the pieces of dirt 112a, 112b on the phosphor layer 72. A butyl rubber roller may be suitably used from the viewpoint that the adhesive roller 120a need have a sufficient dust removal effect while the constituent material of the roller does not remain on the phosphor layer 72.

The adhesive roller 120a preferably has a hardness (Hs JIS-A) of about 30° and an adhesive force as defined by JIS Z0237 of about 91 hPa.

In order to prevent further adhesion of dirt and dust, the phosphor sheet after the end of the removal step in which foreign matter such as dirt and dust has been removed by any of the illustrated methods, is then subjected to the thermal treatment (annealing) in the thermal treatment unit under predetermined conditions with the dust-proof cover 100 attached to the phosphor sheet.

After the end of the thermal treatment, the phosphor sheet is allowed to fully cool and is transported to a moisture-proof protective layer-forming device (not shown) in the subsequent step where the moisture-proof protective layer 74 (see FIG. 6) is formed. An adhesive is applied to the phosphor layer 72 using, for example, a dispenser to form an adhesive layer 76.

Then, a moisture-proof protective film, for example, wound in a roll (not shown) is pulled out and applied onto the adhesive layer 76 by heat lamination so that its outer periphery is closely adhered to the upper edge of the frame 70c inserted into a groove 70b of the substrate 70 to form the moisture-proof protective layer 74 (see FIG. 6). The radiation image conversion panel 80 shown in FIG. 6 can be thus produced.

A protective film onto which an adhesive is applied in advance may be used to form the moisture-proof protective layer 74.

The moisture-proof protective film constituting the moisture-proof protective layer 74 may be, for example, a moisture-proof protective film formed of 3 sub-layers on a polyethylene terephthalate (PET) film: an SiO₂ film; a hybrid sub-layer of SiO₂ and polyvinyl alcohol (PVA); and an SiO₂ film. Other examples of the material that may be preferably used include a glass plate (film); a film of resin such as polyethylene terephthalate or polycarbonate; and a film having an inorganic substance such as SiO₂, Al₂O₃, or SiC deposited on the resin film.

For formation of the moisture-proof protective layer 74 having 3 sub-layers of SiO₂ film/hybrid sub-layer of SiO₂ and PVA/SiO₂ film on the PET film, the SiO₂ films may be formed through sputtering and the hybrid sub-layer of SiO₂ and PVA may be formed through a sol-gel process, for example. The hybrid sub-layer is preferably formed to have a ratio of PVA to SiO₂ of 1:1.

The moisture-proof protective layer 74 preferably has a moisture vapor transmission rate of 0.2 to 0.6 g/(m² day) in an environment of 40° C. and 90% RH.

An additional description is given below of the step of humidification.

After having been formed in the vacuum chamber, the phosphor layer is usually not subjected to a particular treatment but thermally treated (annealed) after the lapse of a predetermined period of time to enhance the sensitivity of the phosphor layer. However, the inventors of the present invention have found that the sensitivity of the phosphor layer can be enhanced by the step of keeping it for 5 minutes to 1 week in an environment of 20° C. to 50° C. and 30% to 80% RH prior to the thermal treatment (in other words, the humidification step) and the basic concept of the inventive process is to substantially incorporate this step thereinto.

It is not necessarily clear why the humidification step is effective in increasing the sensitivity of the phosphor layer, but a definite effect is obtained by way of experiment and this humidification step would be a very effective treatment from a practical viewpoint.

While the radiation image conversion panel production process and the radiation image conversion panel obtained thereby according to the present invention have been described above in detail, the present invention is by no means limited to the foregoing embodiments and it should be understood that various improvements and modifications can of course be made without departing from the scope and spirit of the invention.

### EXAMPLES

On the following pages, the present invention is described in greater detail with reference to specific examples. It should of course be understood that the present invention is by no means limited to the following examples.

The production apparatus (apparatus for producing radiation image conversion panels) in the embodiment shown in FIGS. 1A and 1B was used to produce radiation image conversion panels (phosphor sheets) by various methods described below.

To be more specific, in a first group of experiments, vapor deposition was followed by the treatments in any of nine methods, thus obtaining ten samples of the radiation image conversion panel (phosphor sheet) for each method. The methods applied are as follows:

### (1) A formed phosphor layer was then subjected to a humidification step and a thermal treatment step without taking any particular protective measures against adhesion of dirt thereto (Comparative Example 1);

(2) A formed phosphor layer was covered with a mesh-type, dirt-proof protective cover having fine pores with a diameter of 3 μm. The protective cover was continuously attached until the end of cooling following the thermal treatment step (Example 1);
(3) A formed phosphor layer was covered with a mesh-type, dirt-proof protective cover having fine pores with a diameter of 20 μm. The protective cover was continuously attached until the end of cooling following the thermal treatment step (Example 2);
(4) A formed phosphor layer was covered with a mesh-type, dirt-proof protective cover having fine pores with a diameter of 200 μm. The protective cover was continuously attached until the end of cooling following the thermal treatment step (Example 3);
(5) A formed phosphor layer was covered with a mesh-type, dirt-proof protective cover having fine pores with a diameter of 700 μm. The protective cover was continuously attached until the end of cooling following the thermal treatment step (Example 4);
(6) A formed phosphor layer was covered with a mesh-type, dirt-proof protective cover having fine pores with a diameter of 1000 μm. The protective cover was continuously attached until the end of cooling following the thermal treatment step (Example 5);
(7) A formed phosphor layer was covered with a mesh-type, dirt-proof protective cover having fine pores with a diameter of 2000 μm. The protective cover was continuously attached until the end of cooling following the thermal treatment step (Example 6);
(8) A formed phosphor layer was covered with a mesh-type, dirt-proof protective cover having fine pores with a diameter of 3 μm. The protective cover was detached after the end of the humidification step but before the start of the thermal treatment step (Example 7);
(9) A formed phosphor layer was covered with a mesh-type, dirt-proof protective cover having fine pores with a diameter of 3 μm. The protective cover was detached after the end of the thermal treatment step but before cooling the phosphor layer (Example 8);

In a second group of experiments, vapor deposition was followed by the treatments in any of five methods, thus obtaining ten samples of the radiation image conversion panel (phosphor sheet) for each method. The methods applied are as follows:

(1) An air-blowing type dirt removing device such as an air gun as shown in FIG. 7 was used to remove dirt that adhered or might adhere to a formed phosphor layer, which was followed by the humidification step (with the protective cover unattached), and the dirt removal with the air gun was performed again (air was blown from the air gun at a rate of 5 m/s; the phosphor layer was covered with a plate-like protective cover (i.e., a protective cover having no fine holes) after the end of the dirt removal but before the start of the thermal treatment (Example 9);

### (2) The method is the same as in (1) above except that the rate of air blown from the air gun was set to 50 m/s (Example 10);

### (3) The method is the same as in (1) above except that the rate of air blown from the air gun was set to 75 m/s (Example 11);

### (4) The method is the same as in (1) above except that the rate of air blown from the air gun was set to 0.5 m/s (Example 12);

(5) An adhesive roller (butyl rubber was used for the adhesive material) as shown in FIG. 8 was used to remove dirt that adhered or might adhere to a formed phosphor layer, which was followed by the humidification step (with the protective cover unattached), and the dirt removal with the roller using the same adhesive material was performed again (the phosphor layer was covered with a plate-like protective cover as above after the end of the dirt removal but before the start of the thermal treatment (Example 13);

The samples of the radiation image conversion panels (phosphor sheets) prepared in Examples 1 to 13 and Comparative Example 1 of the two groups of experiments were uniformly exposed to radiation and resulting images were inspected for the number of point defects.

Each of the radiation image conversion panels had a structure as shown in FIG. 6 that includes the substrate 70, the phosphor layer 72 formed on the substrate 70 and the moisture-proof protective layer 74 for hermetically seal the phosphor layer 72.

An aluminum alloy substrate (YH75 manufactured by Hakudo Co., Ltd.) was used for the substrate and the substrate had a size of 450 mm×450 mm×10 mm.

The radiation image conversion panels (phosphor sheets) in Examples 1 to 13 and Comparative Example 1 are different from each other in the treatments after the end of the vapor deposition and the method applied to remove dirt and dust, although the steps before the end of the vapor deposition are the same.

The outline of the process for producing the radiation image conversion panels (phosphor sheets) in Examples 1 to 13 and Comparative Example 1 is now described.

The substrate 70 accommodated in the substrate holder 39 was set in a plasma cleaner. The plasma cleaner was activated to generate an argon plasma in an argon gas atmosphere at a pressure of 1 Pa under the conditions of an electric power of 500 W and a period of 60 seconds to clean the surface of the substrate 70, after which the substrate 70 accommodated in the substrate holder 39 was set in the substrate holding means 26 of the substrate holding and transporting mechanism 14 in the vacuum chamber 12.

Then, a CsBr film-forming material and a EuBr² film-forming material were respectively filled into the crucibles (vessels) 50, 52 for resistance heating in the thermal evaporating section 16 of the vacuum chamber 12.

Cesium bromide (CsBr) powder having a purity of 4 N or more and a molten product of europium bromide (EuBr₂) having a purity of 3N or more were provided as the film-forming materials. In order to prevent oxidation, the molten product of EuBr₂ was prepared by loading the powder into a Pt crucible within a tube furnace that had been fully purged with a halogen gas; the process of preparation included melting by heating to 800° C., cooling and taking out of the furnace. Analysis of trace elements in each of the film-forming materials by ICP-MS (inductively coupled plasma mass spectrometry) showed the following: The alkali metals other than Cs in CsBr (i.e. Li, Na, K, and Rb) were each present in not more than 10 weight ppm whereas other elements such as alkaline earth metals (Mg, Ca, Sr, and Ba) were each present in 2 weight ppm or less; the rare earth elements other than Eu in EuBr₂ were each present in not more than 20 weight ppm and the other elements in 10 weight ppm or less. Since both film-forming materials were highly hygroscopic, they were stored in a desiccator keeping a dry atmosphere with a dew point of −20° C. or lower and taken out just before use.

At a distance of 100 mm from the thermal evaporating section 16, the substrate 70 was linearly transported to form the phosphor layer 72 thereon.

After the CsBr and EuBr₂ film-forming materials were respectively filled into the crucibles (vessels) 50 and 52 for resistance heating, the door 13 of the vacuum chamber 12 was shut to close the vacuum chamber 12. The vacuum pump 18 was activated to evacuate the vacuum chamber 12; at the time when the pressure in the vacuum chamber 12 had reached a predetermined value, say, 8×10⁻⁴ Pa, for example, argon gas was introduced into the vacuum chamber 12 through the opening 19a of the gas introducing nozzle 19 with the evacuating process being continued such that the pressure in the vacuum chamber 12 was adjusted to, for example, 1.0 Pa.

The vapor deposition step was performed under the medium degree of vacuum to prepare 140 samples (10 samples for each of 14 types).

The thus obtained samples each having the phosphor layer 72 formed on the substrate 70 were processed according to the methods as described above to yield the radiation image conversion panels 80, which were then used for performance comparison.

The detailed conditions used in the vapor deposition step are as follows:

After the end of the substrate treatment, the vacuum chamber 12 was evacuated to a degree of vacuum of 8×10⁻⁴ Pa; then, a predetermined amount of argon gas was introduced to achieve a degree of vacuum of 1.0 Pa.

The film-forming materials (CsBr and EuBr₂) were heated and melted using a resistance heating device with the shutter provided between the substrate 70 and the thermal evaporating section 16 (crucibles 50 and 52) closed. After the lapse of 60 minutes from the start of heating, the shutter over the crucibles 50 was only opened and linear transport of the substrate 70 was started to deposit the CsBr phosphor as the matrix on the surface of the substrate 70.

Then, after the lapse of a predetermined period of time from the opening of the shutter over the crucibles 50, the shutter over the crucibles 52 was also opened to start depositing the CsBr:Eu stimulable phosphor on the CsBr phosphor matrix.

The rate of deposition was set to 6 μm/min. The current in each of the crucibles in the thermal evaporating section 16 was adjusted such that the molarity ratio of Eu/Cs in the stimulable phosphor layer could be 0.003:1.

After the end of vapor deposition, the resistance heating device was turned off and the supply of argon gas was stopped.

Then, nitrogen gas or dry air was introduced into the vacuum chamber 12 to restore atmospheric pressure; then, the door 13 was opened to take out the substrate holder 39 containing the substrate 70 from within the vacuum chamber 12.

On the surface 70d of the substrate 70 was formed the phosphor layer 72 that was of a structure in which columnar phosphor crystals densely grew in an approximately vertical direction. The phosphor layer 72 formed had a thickness of 700 μm and an area of 400 mm×400 mm.

Then, in order to enhance the sensitivity, the substrate 70 on which the phosphor layer had been formed was subjected to the humidification. The conditions of the humidification included a temperature of 30° C., a relative humidity of 60% RH and a time period of 6 hours.

Whether the protective cover was attached or not and the method applied for the dirt removal in each of the Examples and the Comparative Example are as described above.

The substrate 70 having the phosphor layer 72 formed thereon was then thermally treated at 200° C. for 20 minutes to enhance the sensitivity.

Whether the protective cover was attached or not in each of the Examples and the Comparative Example is as described above.

In the thermal treatment step, the substrate 70 having the phosphor layer 72 formed thereon was first put on a heating plate (set at 210° C.) disposed in a vacuum heater into which a gas could be introduced. The thermal treatment was performed as described above under the thermal treatment conditions of a temperature of 200° C. and a time period of 20 minutes, while dry air was allowed to flow in the vacuum heater. After the thermal treatment, the substrate 70 having the phosphor layer 72 formed thereon was taken out of the vacuum heater and allowed to cool in the air.

Then, for example, a dispenser was used to apply an adhesive to the phosphor layer 72 and the region on the surface 70d of the substrate 70 where the phosphor layer 72 had not been formed.

Then, a moisture-proof protective film wound in a roll was pulled out and applied onto the phosphor layer 72 by heat lamination so that its outer periphery was closely attached to the surface of the substrate, thus forming the moisture-proof protective layer 74.

Each radiation image conversion panel was thus produced.

A solid image was obtained as a radiation image from each of the radiation image conversion panels produced as described above in Examples 1 to 13 and Comparative Example 1 and checked to see whether there were point defects.

A description is given below of the method of inspecting the radiation image (solid image) obtained from each radiation image conversion panel for point defects.

A tungsten tube was used to expose the entire surface of the radiation image conversion panel to about 10 mR (2.58×10⁻⁶ C/kg) of X-rays at a tube voltage of 80 kVp. After the exposure to X-rays, an image reader of a line scanner type (the radiation image conversion panel was irradiated with semiconductor laser light having a wavelength of 660 nm; photostimulated luminescence emitted from the surface of the radiation image conversion panel was received by a CCD sensor having linearly arranged light receiving elements) was used to read the photostimulated luminescence; the thus read (received) photostimulated luminescence was converted into an electric signal, thus obtaining the solid image as the radiation image; a film having the radiation image (solid image) reproduced as a visible image was output by a laser printer.

Then, for each of the radiation image conversion panels, a resulting radiation image (solid image) recorded on the film was visually checked on a film viewer to see whether there were dropouts (point defects) in the central area of the radiation image (solid image) measuring 10 cm×10 cm (10 cm square; 100 cm²). The number of point defects was thus counted.

The number of point defects due to the radiation image conversion panels is shown in Table 1 (first group of experiments) and Table 2 (second group of experiments and Comparative Example 1).

TABLE 1

| | | | Stain due to foreign matter | | |
|---|---|---|---|---|---|
| | | | Whether | | |
| | | | there is | | |
| Operation steps after vapor deposition | | | stain due | | |
| | Thermal | | to foreign | | |
| Humidification | treatment | Cooling | matter | Number | Remarks |

| EX 1 | Mesh cover (with diameter of 3 μm) | | No | — | |
|---|---|---|---|---|---|
| EX 2 | Mesh cover (with diameter of 20 μm) | | No | — | |
| EX 3 | Mesh cover (with diameter of 200 μm) | | No | — | |
| EX 4 | Mesh cover (with diameter of 700 μm) | | No | — | |
| EX 5 | Mesh cover (with diameter of 1000 μm) | | No | — | |
| EX 6 | Mesh cover (with diameter of 2000 μm) | | Yes | 2 | Mesh was not fine enough |
| | | | | | to prevent dirt |
| EX 7 | Mesh cover | Uncovered | Yes | 1 | Dirt adhered in the |
| | (with diameter | | | | cooling step |
| | of 3 μm) | | | | |

| | | | | |
|---|---|---|---|---|
| EX 8 | Mesh cover (with diameter | Uncovered | Yes | 1 |
| | of 3 μm) | | | |

| | | | |
|---|---|---|---|
| CE 1 | Uncovered | Yes | 5 |

The mesh cover refers to a protective cover with fine pores.

TABLE 2

| | | | | | Stain due to foreign matter | | |
|---|---|---|---|---|---|---|---|
| | | | | | Whether | | |
| | | | | | there is | | |
| Operation steps after vapor deposition | | | | | stain due to | | |
| | | | Thermal | | foreign | | |
| Dirt removal | Humidification | Dirt removal | treatment | Cooling | matter | Number | Remarks |

| | | | | | | | |
|---|---|---|---|---|---|---|---|
| EX 9 | Air blow at | Uncovered | Air blow at | Aluminum cover | No | — | |
| | rate of 5 m/s | | rate of 5 m/s | | | | |
| EX 10 | Air blow at | Uncovered | Air blow at | Aluminum cover | No | — | |
| | rate of | | rate of | | | | |
| | 50 m/s | | 50 m/s | | | | |
| EX 11 | Air blow at | Uncovered | Air blow at | Aluminum cover | No | — | |
| | rate of | | rate of | | | | |
| | 75 m/s | | 75 m/s | | | | |
| EX 12 | Air blow at | Uncovered | Air blow at | Aluminum cover | Yes | 4 | Rate of air |
| | rate of | | rate of | | | | blown was |
| | 0.5 m/s | | 0.5 m/s | | | | too low to |
| | | | | | | | remove dirt |
| EX 13 | Butyl rubber | Uncovered | Butyl rubber | Aluminum cover | No | — | |
| | roller | | roller | | | | |
| CE 1 | No | Uncovered | No | Uncovered | Yes | 5 | |

The aluminum cover refers to a protective cover having no fine pores. The air blow and the butyl rubber roller refer to a dirt removing treatment by means of air blowing and a dirt removing treatment using a dirt removing roller (adhesive roller), respectively.

As shown in Table 1, staining due to 5 pieces of dirt per 100 cm² was found to occur in the radiation image conversion panel in Comparative Example 1, whereas staining of this type was found not to occur in the radiation image conversion panels in Examples 1 to 5 that each used a mesh cover having fine pores with a diameter of up to 1000 μm. In Example 6 in which a mesh cover having fine pores with a diameter of 2000 μm was used, slight staining was found to occur because part of dirt passed through the mesh cover.

The above results show that attaching a mesh cover with a pore size of 1 μm to 1500 μm can fully prevent the radiation image conversion panel from having stains.

Also in the radiation image conversion panels in Examples 7 and 8 in which a mesh cover having fine pores with the smallest diameter of 3 μm was used, slight staining was found to occur because the cover attachment period was short.

Although staining was found to occur in the radiation image conversion panels in Examples 6, 7 and 8, the number of stains generated was clearly smaller than in Comparative Example 1. Therefore, the effects of the present invention are obvious.

As shown in Table 2, staining due to 5 pieces of dirt per 100 cm² was found to occur as described above in Comparative Example 1 in which the dirt removal was not performed prior to the thermal treatment step (Comparative Example 1 shown in Table 2 is the same as that shown in Table 1). On the other hand, staining was found not to occur and the effects of the present invention are obvious in the cases shown in Examples 9 to 13 where the dirt removal was performed, that is, in both of Examples 9 to 11 in which the removal method by means of air blowing was applied and Example 13 in which the dirt removal method using the adhesive roller was applied. In Example 12 in which air was blown at a rate of 0.5 m/s which is less than 2 m/s, dust could not be fully removed because of a low rate of air blown and staining was found to occur due to dust remaining on the panel surface, but Example 12 had a smaller number of stains due to foreign mater such as dust than Comparative Example 1 and achieved an air-blowing effect.

The above results show that staining on the radiation image conversion panel can be fully prevented from occurring in the case where air is blown at a rate of at least 2 m/s.

Tables 1 and 2 confirm that the radiation image conversion panels produced by the radiation image conversion panel production process in the embodiment under consideration cause a significantly reduced number of point defects than the radiation image conversion panel in Comparative Example 1, in other words, the effects of the present invention are significant.

As described above, the radiation image conversion panel production process of the present invention was capable of producing radiation image conversion panels that yield high-quality images with fewer defects.

What is claimed is:

1. A process for producing a radiation image conversion panel comprising the steps of:
forming a phosphor layer on a substrate by vapor-phase deposition in a vacuum chamber; and
subjecting said formed phosphor layer to a thermal treatment to obtain said radiation image conversion panel,
wherein said phosphor layer is protected by a selectively permeable cover after completion of said vapor-phase deposition until completion of said thermal treatment.

2. The process according to claim 1, wherein said selectively permeable cover has fine pores with a diameter of 1 μm to 1.5 mm.

3. The process according to claim 1, further comprising the step of:
keeping said phosphor layer under predetermined temperature and humidity conditions for a predetermined period of time prior to a thermal treatment to be performed on said phosphor layer.

4. The process according to claim 3, wherein said phosphor layer is protected by said selectively permeable cover at least in the step of keeping said phosphor layer under said predetermined temperature and humidity conditions for said predetermined period of time.

5. The process according to claim 3, wherein said selectively permeable cover has fine pores with a diameter of 1 μm to 1.5 mm.

6. A process for producing a radiation image conversion panel comprising the steps of:
forming a phosphor layer on a substrate by vapor-phase deposition in a vacuum chamber;
removing foreign matter on a surface of said phosphor layer; and
subjecting said phosphor layer to a thermal treatment to obtain said radiation image conversion panel,
wherein said foreign matter on said surface of said phosphor layer is removed prior to said thermal treatment performed on said phosphor layer.

7. The process according to claim 6, wherein said foreign matter on the surface of said phosphor layer is removed by blowing air onto the surface of said phosphor layer at a rate of at least 2 m/s.

8. The process according to claim 6, wherein said foreign matter on the surface of said phosphor layer is removed by bringing an adhesive material into contact with the surface of said phosphor layer.

9. The process according to claim 8, wherein a butyl rubber roller is used for said adhesive material.

10. The process according to claim 6, further comprising the step of:
keeping said phosphor layer under predetermined temperature and humidity conditions for a predetermined period of time prior to a thermal treatment to be performed on said phosphor layer.

11. The process according to claim 10, wherein said foreign matter on the surface of said phosphor layer is removed by blowing air onto the surface of said phosphor layer at a rate of at least 2 m/s.

12. The process according to claim 10, wherein said foreign matter on the surface of said phosphor layer is removed by bringing an adhesive material into contact with the surface of said phosphor layer.

13. The process according to claim 12, wherein a butyl rubber roller is used for said adhesive material.

14. A radiation image conversion panel that is produced by a process for producing a radiation image conversion panel, said process comprising the steps of:
forming a phosphor layer on a substrate by vapor-phase deposition in a vacuum chamber; and
subjecting said formed phosphor layer to a thermal treatment to obtain said radiation image conversion panel,
wherein said phosphor layer is protected by a selectively permeable cover after completion of said vapor-phase deposition until completion of said thermal treatment.

15. A radiation image conversion panel that is produced by a process for producing a radiation image conversion panel, said process comprising the steps of:
forming a phosphor layer on a substrate by vapor-phase deposition in a vacuum chamber;
removing foreign matter on a surface of said phosphor layer; and
subjecting said phosphor layer to a thermal treatment to obtain said radiation image conversion panel,
wherein said foreign matter on said surface of said phosphor layer is removed prior to said thermal treatment performed on said phosphor layer.
